(19) United States
(12) Patent Application Publication
(10) Pub. No.: US 2023/0294361 A1
(43) Pub. Date: Sep. 21, 2023

(54) APPARATUS FOR THE EXTRUSION-BASED MANUFACTURE OF AT LEAST ONE THREE-DIMENSIONAL OBJECT

(71) Applicant: Hans Weber Maschinenfabrik GmbH, Kronach (DE)

(72) Inventors: Mario HAMBERGER, Kronach (DE); Felix STUMPF, Kronach (DE)

(73) Assignee: Hans Weber Maschinenfabrik GmbH, Kronach (DE)

(21) Appl. No.: 18/005,829

(22) PCT Filed: Jul. 12, 2021
(86) PCT No.: PCT/EP2021/069288

§ 371 Date: Jan. 17, 2023

(30) Foreign Application Priority Data
Jul. 17, 2020 (DE) 10 2020 118 979.6

(51) Int. Cl. B29C 64/393; B29C 64/118; B29C 64/20

(52) U.S. Cl. CPC B29C 64/393; B29C 64/118; B29C 64/20; B33Y 30/00

(57) ABSTRACT

Apparatus for the extrusion-based manufacture of at least one three-dimensional object, comprising at least one extrusion unit which is configured for melting an extrusion material and/or for applying a molten extrusion material to a substrate, comprising a device which is configured to detect parameter information relating to a process parameter of an extrusion-based manufacturing process which can be carried out or is carried out by means of the apparatus and/or to an object parameter of a three-dimensional object which is to be produced or is produced by means of the apparatus, and to generate position information and/or time information describing a detection position and/or a detection time of corresponding parameter information.

### SUMMARY OF DISCLOSURE

The invention relates to an apparatus for the extrusion-based manufacture of at least one three-dimensional object, comprising at least one extrusion unit which is configured for melting an extrusion material and/or for applying a molten extrusion material to a substrate.

Corresponding extrusion apparatuses for the extrusion-based manufacture of one or more three-dimensional objects are basically known from the prior art.

Although three-dimensional objects in a wide variety of spatial and physical configurations can be reliably produced with the appropriate extrusion equipment, there is a need for better monitoring of the corresponding construction and manufacturing processes, e.g. for the purpose of process monitoring, and thus also for better control if necessary.

Where technical approaches to this already exist, they are in need of improvement or further development, particularly with regard to the informative value and reliability of the monitoring results.

The object of the invention is that of providing an extrusion apparatus with an improved possibility for implementing a process monitoring.

The object is achieved by means of an apparatus for the extrusion-based manufacture of at least one three-dimensional object according to claim 1. The claims dependent thereon relate to possible embodiments of the extrusion apparatus.

A first aspect of the invention described herein relates to an apparatus for the extrusion-based manufacture of at least one three-dimensional object. The term “object” can generally be understood to mean any three-dimensional object or any portion of a three-dimensional object. A three-dimensional object may be, for example, a technical component or a technical assembly group. A section of a three-dimensional object can therefore be a section of a technical component or a section of a technical assembly group.

The apparatus is configured for the extrusion-based manufacture of at least one three-dimensional object. In particular, the apparatus is configured for the extrusion-based manufacture of at least one three-dimensional object via an at least section-wise, optionally complete, layer-wise or layer-by-layer extrusion-based construction of a corresponding three-dimensional object. The extrusion-based manufacture of a corresponding three-dimensional object can thus be carried out by means of the apparatus at least in sections, optionally completely, in layers. The apparatus is accordingly configured for the extrusion-based processing of at least one extrusion material, i.e. for the extrusion of at least one extrusion material onto a substrate. Extrusion material typically means an extrudable plastic material. An extrusion material that can be processed by means of the extrusion apparatus is therefore typically a thermoplastic extrudable plastic material. In particular, thermoplastic extrudable plastic materials are eligible. The term “plastic material” may also include mixtures of at least two chemically different plastic materials and/or mixtures of at least one plastic material with at least one further material, such as a filler material.

The apparatus typically comprises at least one extrusion unit, which is configured for melting or plasticizing a corresponding extrusion material and for applying, in particular in web or strand form, a molten extrusion material to a substrate, such as, for example, a building platform or an object, or to a layer or stratum of the extrusion material or of an extrusion material that has already been applied to a substrate, which may also be understood to mean only a single web or strand of material. In particular, the extrusion unit is configured to apply a melted extrusion material continuously or quasi-continuously, i.e., for example, in a continuous or quasi-continuous material or melt strand or in a continuous or quasi-continuous material or melt strand, to a substrate.

The extrusion unit can be mounted so as to be movable in at least one translatory and/or rotatory degree of freedom of movement relative to a substrate and/or to a three-dimensional object. The extrusion unit can therefore be assigned a drive device, in particular a motor drive device, by means of which a driving force or a corresponding driving torque can be generated which sets the extrusion unit into a translatory and/or rotatory movement along a direction relative to a substrate and/or to a three-dimensional object. A corresponding drive device can be part of a support device, which is arranged for movably bearing the extrusion unit in at least one translatory and/or rotatory degree of freedom of movement relative to a substrate and/or to a three-dimensional object. A corresponding support device can therefore be configured, for example, as a single-axis or multi-axis robot device or comprise such a device.

A corresponding extrusion unit typically comprises at least one extruder chamber, at least one extruder screw arranged in the extruder chamber and defining an extruder axis, and at least one, in particular nozzle-like or nozzle-shaped, outlet region, via which molten extrusion material can be discharged onto a substrate by means of the extrusion unit. A corresponding outlet region typically comprises at least one, in particular nozzle-like or nozzle-shaped, outlet opening, via which molten extrusion material can be discharged onto a substrate by means of the extrusion unit.

The extruder chamber is typically formed by a single- or multi-part extruder chamber assembly bounding or defining the extruder chamber. Accordingly, the extruder chamber may be formed in one or more parts. The extruder chamber assembly typically includes one or more extruder chamber walls bounding or defining the extruder chamber. The extruder chamber can have differently functionalized regions or regions, such as a filling region in which filling of the extruder chamber with extrusion material to be melted takes place, a melting region in which melting of the extrusion material to be melted filled into the extruder chamber takes place, and an outlet region via which melted extrusion material can be discharged onto a substrate by means of the extrusion unit. The outlet region can be arranged or formed in a nozzle section of the extruder chamber (assembly).

The aforementioned components of the extrusion unit can be coupled together to form an extrusion assembly, or coupled together during operation of the extrusion unit.

The apparatus further comprises a hardware- and/or software-implemented device which is configured for the detection of parameter information relating to a process parameter of an extrusion-based manufacturing process which can be carried out or is carried out by means of the apparatus, and/or relating to an object parameter of a three-dimensional object which is to be manufactured or is manufactured by means of the apparatus, and for the generation of position information and/or time information describing a detection position and/or a detection time of corresponding parameter information.

The device can therefore be used to acquire parameter information relating to process parameters of an extrusion-based manufacturing process that can be carried out or is carried out by means of the apparatus, i.e. generally parameters that directly or indirectly describe an extrusion-based manufacturing process that can be carried out or is carried out by means of the apparatus, and/or relating to object parameters of a three-dimensional object that is to be manufactured or is manufactured by means of the apparatus, i.e. generally parameters that directly or indirectly describe a three-dimensional object that is to be manufactured or is manufactured by means of the apparatus. By means of corresponding parameter information—which may, for example, be data that can be processed by means of data processing—both manufacturing processes that can be carried out or are carried out by means of the apparatus and three-dimensional objects that can be manufactured or are manufactured by means of a manufacturing process that can be carried out or is carried out by means of the apparatus can therefore be described at least partially, if necessary completely.

Exemplary process parameters that can be detected by means of the device are explained in more detail below in a non-exhaustive manner:

A corresponding process parameter can describe at least one chemical and/or at least physical parameter of a process space in which an extrusion-based manufacturing process that can be performed or is performed by means of the apparatus takes place. A corresponding chemical parameter of a process space may in particular be a chemical composition of an atmosphere prevailing within the process space, in particular a gas atmosphere. Of course, a corresponding chemical parameter may be a gradient of an atmosphere prevailing within the process space, in particular a gas atmosphere. A corresponding physical parameter of a process space may be, in particular, a pressure prevailing within the process space or a temperature prevailing within the process space. Of course, a corresponding physical parameter can be a gradient of a pressure prevailing within the process space or a temperature prevailing within the process space.

Alternatively or additionally, a corresponding process parameter may describe at least one chemical and/or geometric and/or physical parameter of at least one extrusion material that can be used or is used in the context of an extrusion-based manufacturing process that can be carried out or is carried out by means of the apparatus. A corresponding chemical parameter of an extrusion material may in particular be a chemical composition of an extrusion material. Of course, a corresponding chemical parameter may be a gradient of a chemical composition of an extrusion material. A corresponding geometric parameter of an extrusion material, in particular of an extrusion material web applied to a substrate, i.e. in particular a corresponding material or melt strand or a corresponding material or melt strand, can in particular be a dimension, in particular a height, length, width, and/or a shape, in particular a cross-sectional shape, of an extrusion material, in particular of a material or melt strand or a material or melt strand applied to a substrate. Of course, a corresponding geometric parameter can be a gradient of a dimension, in particular a height, length, width, and/or a shape, in particular a cross-sectional shape, of an extrusion material, in particular of a material or melt strand applied to a substrate or of a material or melt strand applied to a substrate. A corresponding physical parameter of an extrusion material may be, in particular, a density, a strength, a temperature, a surface texture or a viscosity of an extrusion material. Of course, a corresponding physical parameter may be a gradient of a density, a strength, a temperature, a surface condition, or a viscosity of an extrusion material.

Alternatively or additionally, a corresponding process parameter can describe a parameter, in particular a movement parameter, possibly local and/or temporal, of a movement path of the extrusion unit and/or of a material or melt strand applied to a substrate via the extrusion unit or of a material or melt strand applied to a substrate.

Alternatively or additionally, a corresponding process parameter may describe a parameter of a substrate, such as a building platform. In particular, a corresponding parameter of a substrate may be a temperature, a surface condition, of a substrate. Of course, a corresponding parameter can be a gradient of a temperature or a surface condition of a subsurface.

Exemplary object parameters that can be detected by means of the device are explained in more detail below in a non-exhaustive manner:

A corresponding object parameter can describe at least one chemical and/or geometric and/or at least physical parameter of a three-dimensional object or object section to be produced or produced by means of the apparatus. A corresponding chemical parameter can in particular be a chemical composition of a three-dimensional object or object section to be produced or produced by means of the apparatus. Of course, a corresponding chemical parameter may also be a gradient of a chemical composition of a three-dimensional object or object section to be produced or produced by means of the apparatus. In particular, a corresponding geometric parameter can be a dimension, in particular a height, length, width, and/or shape, in particular a cross-sectional shape, of a three-dimensional object or object section to be produced or produced by means of the apparatus. Of course, a corresponding geometric parameter can be a gradient of a dimension, in particular a height, length, width, and/or a shape, in particular a cross-sectional shape, of a three-dimensional object or object section to be produced or produced by means of the apparatus. A corresponding physical parameter can be, in particular, a density, a mass, a surface quality, or a strength of a three-dimensional object or object section to be produced or produced by means of the apparatus. Of course, a corresponding physical parameter can also be a gradient of a density, a mass, a surface quality or a strength of a three-dimensional object or object section to be produced or produced by means of the apparatus.

As mentioned, in addition to the detection of corresponding parameter information, the device is also configured to generate position information and/or time information, such as location and/or time coordinates, which describe a detection position and/or a detection time of a corresponding parameter information. The device is typically also configured for assigning a position information and/or time information describing a detection position and/or a detection time of a corresponding parameter information to a respective parameter information. By means of the device, corresponding position information and/or time information can therefore be generated for and assigned to respective detected parameter information. Each piece of parameter information can therefore be provided with a “location and/or time stamp”, which can be used to identify the location and/or time at which the respective piece of parameter information was detected. The location can be described by parameters, such as coordinates, which define a unique position of the location in a spatial volume, i.e. in particular in a construction volume of the apparatus or in a volume of a three-dimensional object to be produced or produced by means of the apparatus.

The device can therefore comprise, on the one hand, a hardware- and/or software-implemented detection device which is configured to acquire parameter information which, as mentioned, relates to a process parameter of an extrusion-based manufacturing process which can be carried out or is carried out by means of the apparatus and/or an object parameter of a three-dimensional object which is to be manufactured or is manufactured by means of the apparatus, and, on the other hand, a hardware- and/or software-implemented assignment device which is configured to assign to a corresponding parameter information a position information and/or time information which describes a respective detection position and/or a detection time of a corresponding parameter information.

By means of the device, therefore, a meaningful process monitoring and evaluation can be realized, which can take into account both corresponding process parameters and corresponding object parameters, so that a spatially and/or temporally resolved data-related image of a manufacturing process that can be carried out or is carried out by means of the apparatus as well as a spatially and/or temporally resolved data-related image of a three-dimensional object to be manufactured or manufactured by means of a manufacturing process that can be carried out or is carried out by means of the apparatus can be obtained. In particular, the possibility of generating or assigning corresponding position information and/or time information to respective parameter information provides a meaningful image of a manufacturing process or the (successive) construction of a three-dimensional object, since the manufacturing process or the (successive) construction of a three-dimensional object can be reconstructed, if necessary, in real time, with spatial and/or temporal resolution.

Overall, this provides an improved apparatus for the extrusion-based manufacture of at least one three-dimensional object.

As mentioned, the device can comprise a detection device which comprises at least one detection element which is configured to detect parameter information. The detection device can in particular be configured as a sensor device, which comprises at least one sensor element, which is configured for the detection of parameter information.

A corresponding detection device can be specifically configured, for example, as an acoustic and/or optical and/or thermal detection device, which comprises at least one detection element for acoustic and/or optical and/or thermal detection of parameter information. The detection device can thus be configured in particular as an acoustic and/or optical and/or thermal sensor device, which comprises an acoustic and/or optical and/or thermal sensor element. An acoustic detection or sensor element can be, for example, a sound element, in particular an ultrasonic sensor element, an optical detection or sensor element can be, for example, an image detection element, such as a CCD sensor element, a pixel sensor element, etc., a thermal detection or sensor element can be, for example, a temperature detection element, such as an infrared sensor element. In principle, all detection or sensor elements can be used which enable detection of corresponding parameter information, so that supplementary reference is made to electromagnetic detection or sensor elements by way of example.

Of course, the device or the detection device or an evaluation device implemented in hardware and/or software assigned to the detection device can be configured to generate corresponding parameter information on the basis of the signals supplied by respective detection or sensor elements. A corresponding evaluation device can form a hardware and/or software component of the device.

With regard to the arrangement of the device, i.e. in particular of a corresponding detection device, there are basically two different possibilities. The device or a corresponding detection device can either be stationary and thus immovable or fixed in position, or non-stationary and thus movable or not fixed in position.

In the stationary variant, the device or a corresponding detection device may be directly or indirectly arranged or formed on a stationary component of the apparatus, such as a housing structure, a building platform, etc.

In the non-stationary variant, the device or a corresponding detection device can be arranged or formed directly or indirectly on a non-stationary and thus a movably mounted component of the apparatus, such as, for example, on or in a movably mounted arm of a bearing or robot device or on or in the extrusion unit movably mounted as mentioned, whereby it is not itself (actively) movably mounted relative to the non-stationary component of the apparatus. Movements of the device or the corresponding detection device typically result here from the movements of the movably mounted component of the apparatus.

Likewise, in the non-stationary variant, the device or corresponding detection device may be arranged or formed directly or indirectly on or in a stationary component of the apparatus, such as a housing structure, a building platform, etc., wherein it is arranged or formed to be movable in at least one degree of freedom of movement relative to the stationary component of the apparatus. Movements of the device or the corresponding detection device typically result here from the (active) movements of the device or the detection device relative to the stationary component of the apparatus.

Likewise, in the non-stationary variant, the device or a corresponding detection device can be arranged or formed directly or indirectly on or in a non-stationary and thus movably mounted component of the apparatus, such as, for example, on or in a movably mounted arm of a bearing or robot device or on or in the, as mentioned, movably mounted extrusion unit, but in which case it is additionally arranged or formed movably relative to the non-stationary and thus movably mounted component of the apparatus in at least one degree of freedom of movement. Movements of the device or the corresponding detection device typically result here from the (active) movements of the movably mounted component of the apparatus and/or from the (active) movements of the device or the detection device relative to the movably mounted component of the device. The device or the corresponding detection device can be movable here depending on or independently of movements of the movably mounted component of the apparatus relative thereto. In this way, combined or superimposed movements of the device or of a corresponding detection device can be realized, which result from a combination of one or more movements of the movably mounted component of the apparatus, e.g. relative to a substrate, and, on the other hand, one or more movements of the device movably mounted on or in the respective movably mounted component of the device or of the corresponding detection device, e.g. relative to the movably mounted component of the apparatus.

In other words, in all non-stationary variants, the device or a corresponding detection device may be movable in at least one degree of freedom of movement relative to a stationary and thus non-movably supported component of the apparatus and/or may be movable in at least one degree of freedom of movement relative to a non-stationary and thus movably supported component of the apparatus. Corresponding degrees of freedom of movement of respective non-stationary components of the apparatus and the device or the corresponding detection device may be translational and/or rotational degrees of freedom of movement. In principle, it applies that via corresponding movements of the device or the detection device, both changes of the orientation, in particular with unchanged position, or changes of the position, in particular with unchanged orientation, of the device or the corresponding detection device can be realized.

Basically, for the non-stationary variant, movements of the detection device can be carried out on the basis of control data, i.e. in particular movement data, of the extrusion unit. Movements of the detection devices can thus directly or indirectly follow movements of the extrusion unit, which are described by corresponding control or movement data.

Alternatively or in addition, however, it is possible that movements of the detection device are carried out on the basis of other data, i.e., for example, on the basis of detection data of certain chemical and/or physical parameters, such as, for example, a possibly varying temperature of, for example, a substrate, a chemical atmosphere varying, for example, due to an outgassing of an extrusion material, etc. In a specific example, the detection device can thus be moved, for example, following a specific detected temperature profile. Corresponding sensing data may be sensed by the detection device or detection elements assigned thereto, or by a detection device separate from the detection device.

In the embodiment already mentioned, in which the device or a corresponding detection device is arranged or formed on or in the extrusion unit, the device or a corresponding detection device, i.e. in particular at least one detection element assigned to the detection device, can be arranged or formed in the region of a, in particular nozzle-like or -shaped, outlet region of the extrusion unit. As also mentioned, the extrusion unit typically comprises an extrusion chamber, an extruder screw arranged in the extrusion chamber and an outlet region, in particular a nozzle-like or nozzle-shaped outlet region, via which molten extrusion material can be discharged onto a substrate by means of the extrusion unit. By means of such an arrangement or design of the device or of a corresponding detection device in the region of a, in particular nozzle-like or -shaped, outlet region of the extrusion unit, corresponding parameter information can be detected directly in the region of the material output. Depending on the specific arrangement or orientation of the device or the corresponding detection device and depending on the specific path of movement of the extrusion unit, parameter information can thus be detected, for example, in advance of and/or in retrospect of a web of material or melt to be applied to a substrate by means of the extrusion unit or of a strand of material or melt to be applied to a substrate by means of the device. This can provide very relevant and meaningful information with regard to the aforementioned process monitoring and evaluation.

In this context, the device or a corresponding detection device, i.e. in particular a detection element, can in particular be arranged or configured so as to be movable in at least one translatory and/or rotatory degree of freedom of movement relative to the outlet region in the region of the outlet region. Translational movements of the device or of the corresponding detection device, i.e. in particular of a detection element, can in particular take place along a translation axis defined by the extruder axis or along a translation axis oriented at an angle, i.e. in particular at right angles, to the extruder axis. Rotational movements of the device or of the corresponding detection device, i.e. in particular of a detection element, can in particular take place about an axis of rotation defined by the extruder axis or an axis of rotation oriented at an angle, i.e. in particular at right angles, to the extruder axis.

By means of corresponding movements of the device or of the corresponding detection device, i.e. in particular of a detection element, parameter information can be detected, e.g. leading and/or trailing to a material or melt strand to be applied to a substrate by means of the extrusion unit or to a material or melt strand to be applied to a substrate by means of the device. A lateral detection of parameter information with respect to a longitudinal extension of a corresponding material or melt strand or a corresponding material or melt strand is also conceivable. Consequently, parameter information can be detected, in particular also simultaneously with a movement of the extrusion unit along a movement path following a cross section of a three-dimensional object to be produced, in which a material or melt strand or a material or melt strand is applied to a substrate, in one or more orientations and/or positions around the outlet region of the extrusion unit, so that very relevant and meaningful information can be obtained with regard to the aforementioned process monitoring and evaluation.

The device or a corresponding detection device can, as mentioned, basically comprise several detection elements. In a variant with several detection elements, these can be arranged to form a detection element arrangement, in particular forming an array. An array can, for example, be a planar or ring-shaped structure. In this way, a detection region, in particular a flat or ring-like or ring-shaped region, can be defined. In a corresponding detection region, respective detection elements can each be assigned to at least one subregion in order to detect corresponding parameter information in the respective subregion.

In all embodiments, the movable mounting of the device or of a corresponding detection device can be implemented by means of at least one drive device, in particular a motor drive device, which can be directly or indirectly assigned or assigned to the device or the corresponding detection device and is configured to generate a drive force or a corresponding drive torque which sets the device or the corresponding detection device in motion in at least one degree of freedom of movement. The device or a corresponding detection device can also be assigned to or associated with a guide device which comprises one or more guide elements which each define at least one movement path or at least one degree of freedom of movement along which the device or a corresponding detection device can be moved.

At this point, it should be noted in general that the device or a plausibility device that can be assigned or is assigned to the device in terms of hardware and/or software can be configured to check, for example, parameter information supplied by different detection elements with regard to at least one plausibility criterion. For example, parameter information, such as temperature information, supplied by a first detection element can be compared with parameter information, such as temperature information, supplied by a further detection element, and the comparison result can be checked for plausibility with regard to at least one plausibility criterion, such as a specific absolute or relative deviation, a reference value, etc. A corresponding plausibility device can form a hardware and/or software component of the device.

In general, it should be noted for variants of a detection device with several detection elements that the detection regions of the respective detection elements can overlap at least in sections, if necessary, completely. Consequently, in a corresponding overlapping region, if necessary, several parameter information items with the same, similar or different information content can be acquired via several, possibly different, detection elements, so that very relevant and meaningful information can be obtained with regard to the aforementioned process monitoring and evaluation.

Further, for variants of a detection device with multiple detection elements, it is generally noted that the detection elements are either operated permanently or, for instance to ensure that only relevant parameter information is sensed, based on at least one, e.g. static or dynamic, location criterion, i.e. e.g. only when one or more detection elements are in a certain orientation and/or position, and/or on the basis of at least one, e.g. static or dynamic, time criterion, i.e. e.g. only at certain points in time, and/or on the basis of a static or dynamic movement criterion of the extrusion unit, i.e. e.g. only when the extrusion unit is moving along an extrusion material web. Respective location and/or time criteria can be determined, for example, on the basis of construction data of a respective three-dimensional object to be produced.

The device can be configured to generate one or more image information items describing a one-dimensional or multi-dimensional image of corresponding parameter information. The term “image information” is not only to be understood to mean image files, rather the term basically includes any file or any file content from which corresponding one- or multi-dimensional images of corresponding parameter information can be created directly or indirectly by data processing. The device can therefore be configured to process corresponding parameter information and/or corresponding position information and/or time information by means of data processing to form a one-dimensional or multi-dimensional image of a manufacturing process that can be carried out or is carried out by means of the device and/or of a three-dimensional object that can be manufactured or is manufactured by means of the device. A corresponding image can include the mentioned spatially and/or temporally resolved illustration of a manufacturing process that can be carried out or is carried out by means of the device or of the structure of a three-dimensional object that can be manufactured or is manufactured by means of the device, which can enable the likewise mentioned spatially and/or temporally resolved reconstruction of the manufacturing process or of the structure of the three-dimensional object.

The device may further comprise at least one output device, which is configured to output corresponding image information at or via an output element. The term “output” in this context means both a display of corresponding image information on an output element comprising a display surface, such as a display, and the wired or wireless data transmission of corresponding image information via an output element comprising a data transmission interface. Corresponding image information—the same also applies to corresponding parameter information together with position information and/or time information assigned thereto—can, for example, be transmitted to an external communication partner, such as an external data processing device and/or an external data storage device, for the purpose of further evaluation or processing or mere storage, for example in order to implement archiving or documentation of a manufacturing process.

The device or a hardware and/or software comparison device that can be assigned or is assigned to the device can be configured to compare corresponding parameter information with at least one, in particular corresponding, reference parameter information and to generate comparison information describing a respective comparison result. By means of the respective comparison information, meaningful statements can in turn be made, in particular in a spatially and/or temporally resolved manner, about the quality of a manufacturing process which can be carried out or is carried out by means of the apparatus and/or of a three-dimensional object which is to be manufactured or is manufactured by means of the apparatus, so that very relevant and meaningful information can be obtained with regard to the aforementioned process monitoring and evaluation.

The apparatus may comprise a control device implemented in terms of hardware and/or software, which is configured for controlling the operation of the apparatus, in particular the operation of the extrusion unit of the apparatus or of a support device of the apparatus supporting the extrusion unit. In particular, the control device can be configured to control the operation of the apparatus, in particular the operation of the extrusion unit of the apparatus or of a support device of the apparatus supporting the extrusion unit, on the basis of corresponding parameter information and/or on the basis of corresponding comparison information. Consequently, corresponding parameter information and/or comparison information can be used as a basis for controlling the operation of the apparatus, in particular of the extrusion unit of the apparatus or of a support device of the apparatus supporting the extrusion unit. This can also include that on the basis of corresponding parameter information or comparison information, for example, certain operating parameters of the apparatus can be adjusted, in particular in real time or generally during operation of the apparatus, at least temporarily, for example in order to compensate for detected deviations of a certain process parameter and/or object parameter. Similarly, process parameters and/or object parameters can be adapted or changed, for example to compensate for and/or offset detected deviations of a particular process parameter and/or object parameter. Specifically, a corresponding adaptation may include, for example, an at least temporary adaptation or modification of a movement path of the extrusion unit or of a support device of the apparatus supporting the extrusion unit, and/or an at least temporary adaptation or modification of the application or discharge quantity of extrusion material onto a substrate, or an at least temporary adaptation or modification of a movement profile, in particular a movement path, a movement speed, etc., of a support device of the apparatus supporting the extrusion unit. Thus, for example, movements and/or application or discharge quantity of the extrusion unit can be adjusted in-situ during operation on the basis of corresponding parameter information and/or on the basis of corresponding comparison information during operation of the apparatus, i.e. in particular during a construction process.

In principle, it applies in this context that control data for the operation of the apparatus, i.e. in particular of the extrusion unit, are adapted or even newly generated on the basis of corresponding parameter information and/or on the basis of corresponding comparison information.

The apparatus can comprise a temperature control device associated with the device, i.e. in particular a corresponding detection device, further in particular at least one corresponding detection element, which is configured for temperature control, in particular for cooling, of the device. The possibility of temperature controlling the device, i.e. in particular a corresponding detection device, further in particular at least one corresponding detection element, can ensure proper operation of the device, i.e. in particular proper detection of corresponding parameter information, even under adverse thermal conditions, i.e. in particular at, for example, process-related high temperatures. In addition, thermally induced failures or damage to the detection device or a detection element can be avoided. A corresponding temperature control device can generally be configured for active or passive temperature control of the detection device or a detection element.

Specifically, a corresponding temperature control device can, for example, be configured as or comprise a heat exchanger device, which can also be referred to as a heat transfer device. The temperature control device can therefore be configured, e.g. via a (first) temperature control fluid—this can be a gas or a liquid—flowing along the detection device or at least one detection element, to absorb thermal energy of a first energy level from the detection device and to transfer this to a temperature control structure, i.e. e.g. a cooling fin structure, and/or, possibly with the interposition of a heat transfer structure, to a further temperature control fluid.

The heat exchanger device may comprise at least two flow channel structures. A first flow channel structure through which a first temperature control fluid, i.e. e.g. a gas, can flow can extend, for example, through a first spatial volume in which the device, i.e. in particular at least one detection element of a corresponding detection device, is arranged or formed. A second flow channel structure through which a second temperature control fluid, i.e., for example, a liquid, can flow or is flowed through can extend through a second spatial volume separated from the first spatial volume by a heat transfer structure, in particular a wall structure. The second spatial volume can be formed, for example, by groove-like recesses which are covered by at least one, for example plate-like or plate-shaped, end or cover element on which one or more discharge and/or supply elements for discharging and/or supplying a temperature control fluid can be arranged or formed. This configuration of the heat exchanger device with at least two separate but thermally couplable or coupled flow channel structures enables efficient dissipation of thermal energy and thus efficient cooling of respective detection elements.

One or more flow generation devices, i.e., e.g., blower and/or pump devices, can be assigned to respective flow channel structures, which enable the respective temperature control fluid to be conveyed through the spatial volumes associated with the respective flow channel structures. The operation of respective flow generation devices can be controlled or regulated on the basis of temperature information generated by a temperature sensor.

The first spatial volume can be a first spatial volume, e.g. chamber-like or -shaped, of a housing assembly of a corresponding detection device, on or in which at least one corresponding detection element is arranged or formed. The second spatial volume, which is likewise e.g. chamber-like or -shaped, can be a second spatial volume of a corresponding housing assembly, which is separated from the first spatial volume by a wall structure serving as a heat transfer structure, so that, although there is a transfer of thermal energy, there is no possibility of mixing of the temperature control fluids flowing through the respective spatial volumes.

A corresponding housing assembly may also comprise a third volume which communicates with the first volume through which the first temperature control fluid can flow, e.g. through at least one opening, and which is also chamber-like or chamber-shaped. At least one temperature control structure, i.e., for example, a cooling fin structure, can be arranged or formed in the third spatial volume, which is thermally coupled to the second spatial volume, through which the second temperature control fluid can flow or is flowing, via the wall structure or a wall structure serving as a heat transfer structure. This configuration can increase the efficiency of thermal energy transfer.

The above statements apply in particular in connection with an embodiment in which the device or the detection device are arranged or formed on or in a non-stationary and thus movably mounted component of the apparatus, such as, for example, on or in a movably mounted arm of the or a robot device or on or in the movably mounted extrusion unit, i.e., in particular in the region of the outlet region of the extrusion unit.

It follows from the foregoing that the device or detection device may generally be arranged or formed on or in a housing assembly defining at least one chamber-like spatial volume. A corresponding housing assembly may be arranged or formed on a movably mounted component of the device, such as, for example, on or in a movably mounted arm of the or a robot device or on or in the movably mounted extrusion unit, i.e., in particular in the region of the outlet region of the extrusion unit. A corresponding housing assembly can have an opening through which the extrusion unit can pass or through which, for example if the extrusion unit is arranged above the housing assembly, an extrusion material to be applied to a substrate can pass.

It has been mentioned that a detection element may be arranged or formed to be movable in at least one translatory and/or rotatory degree of freedom of movement relative to the outlet region. Rotational movements of a detection element may, as likewise mentioned, also be about an axis of rotation oriented at right angles and thus transversely to the extruder axis. At least one detection element can accordingly be pivotally mounted, for example, which makes it possible to align the detection region of the detection element directly with the or a region below the outlet region of the extrusion unit in order to detect parameter information in this region.

Equally, however, irrespective of the possibility of moving corresponding detection elements in one or more degrees of freedom of movement, it is conceivable that the detection elements are arranged or aligned with a respective detection region which is aligned with the or a region below the outlet region of the extrusion unit. The detection region of respective detection elements can thus be aligned or oriented in particular to a region below the outlet region of the extrusion unit. In this way, parameter information can be detected particularly well in this region.

A second aspect of the invention relates to a method for extrusion-based manufacturing of at least one three-dimensional object. The method comprises the following steps: detection of at least one parameter information relating to a process parameter of an extrusion-based manufacturing process which can be carried out or is carried out by means of the apparatus and/or an object parameter of a three-dimensional object which is to be manufactured or is manufactured by means of the apparatus, and generation of a position information and/or time information describing a detection position and/or a detection time of a corresponding parameter information object information.

All embodiments relating to the apparatus according to the first aspect of the invention apply analogously to the method according to the second aspect of the invention.

Accordingly, the method may comprise, for example, the step of controlling the operation of the apparatus, i.e. in particular the extrusion unit of the apparatus or a support or robot device of the apparatus supporting the extrusion unit, on the basis of corresponding parameter information and/or on the basis of corresponding comparison information.

### BRIEF DESCRIPTION OF THE DRAWINGS

The invention is explained again by means of exemplary embodiments in the drawings.

FIG. 1 is a principle illustration of an apparatus for the extrusion based manufacture of a three dimensional object.

FIG. 2 is a side view illustration of the exemplary embodiment.

FIG. 3 is a top view illustration of the exemplary embodiment.

FIG. 4 is an illustration of the exemplary embodiment showing the detection device and detection elements.

FIG. 5 is an illustration that one or more detection elements 7.1 can also form an array in the form of an annular structure.

FIG. 6 is an illustration of a housing assembly of a device according to an embodiment.

FIG. 7 is an illustration showing the housing assembly horizontally cut-through.

FIG. 8 is an illustration showing the housing assembly horizontally cut-through.

FIG. 9 is an illustration showing the housing assembly horizontally cut-through.

FIG. 10 is an illustration showing the housing assembly transverse cut-through.

### DETAILED DESCRIPTION

The apparatus 1 is therefore configured for the extrusion-based manufacture of at least one three-dimensional object, i.e. in particular for the extrusion-based manufacture of at least one three-dimensional object by means of an at least sectional, if necessary complete, layer-by-layer extrusion-based construction of a corresponding three-dimensional object. The extrusion-based manufacture of a corresponding three-dimensional object can thus be carried out by means of the apparatus 1 at least in sections, optionally completely, in layers. The apparatus 1 is accordingly configured for extrusion-based processing of at least one extrusion material, i.e. for extrusion of at least one extrusion material onto a substrate. An extrusion material is typically understood to be an extrudable plastic material.

The apparatus 1 comprises an extrusion unit 2, which is configured for melting or plasticizing a corresponding extrusion material and for applying, in particular in web or strand form, a molten extrusion material to a substrate, such as, for example, a building platform 3 or an object, or to a layer or stratum of the extrusion material or of an extrusion material that has already been applied to a substrate, which may also be understood to mean only a single web or strand of material. The extrusion unit 2 is in particular configured to apply a melted extrusion material continuously or quasi-continuously, i.e., for example, in a continuous or quasi-continuous material or melt strand or in a continuous or quasi-continuous material or melt strand, to a substrate.

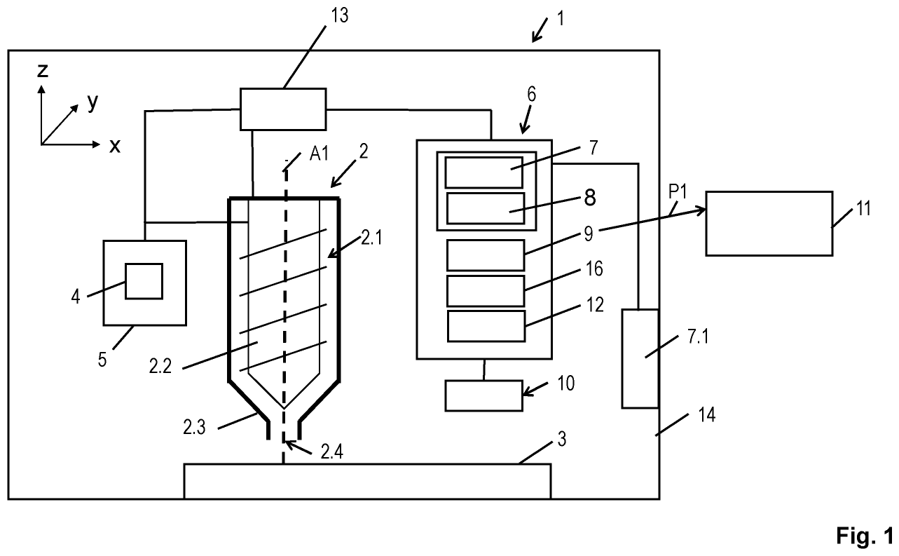

The extrusion unit 2 is mounted so as to be movable relative to a substrate in at least one translatory and/or rotatory degree of freedom of movement. Exemplary translational degrees of freedom of movement of the extrusion unit 2 are translational movements along one or more axes of the coordinate system shown in FIG. 1, exemplary rotational degrees of freedom of movement of the extrusion unit 2 rotational axes are rotational movements about one or more of the axes of the coordinate system shown in FIG. 1.

As indicated in FIG. 1, the extrusion unit 2 can be assigned a drive device, in particular a motorized drive device, by means of which a driving force or a corresponding driving torque can be generated which sets the extrusion unit 2 in a translatory and/or rotatory movement along a path relative to a substrate. In the exemplary embodiment shown in FIG., the drive device 4 forms a component of a support device 5, which is configured for the movable bearing of the extrusion unit 2 in at least one translatory and/or rotatory degree of freedom of movement relative to a substrate. The support device 5 shown purely schematically in Figs. can be configured, for example, as a single-axis or multi-axis robot device or comprise such a device.

As indicated in FIG. 1, the extrusion unit 2 comprises an extruder chamber 2.1 delimited or defined by one or more extruder chamber walls, an extruder screw 2.2 arranged in the extruder chamber 2.1 and defining an extruder axis A1, and an outlet region 2.3, in particular a nozzle-like or nozzle-shaped one, via which extrusion material melted in the extruder chamber 2.1 by means of the extrusion unit 2 can be discharged onto a substrate. The outlet region 2.3 comprises an outlet opening 2.4, in particular a nozzle-like or nozzle-shaped outlet opening 2.4, through which extrusion material melted by means of the extrusion unit 2 can be discharged onto a substrate.

The extruder chamber 2.1 can have differently functionalized regions or regions, such as, for example, a filling region, in which the extruder chamber 2.2 is filled with extrusion material to be melted, a melting region, in which the melting of the extrusion material to be melted filled into the extruder chamber 2.1 takes place, as well as the aforementioned outlet region 2.3, via which extrusion material melted by means of the extrusion unit 2 can be discharged onto a substrate.

The aforementioned components of the extrusion unit 2 can be coupled together to form an extrusion assembly, or coupled together during operation of the extrusion unit.

The apparatus 1 further comprises a hardware- and/or software-implemented device 6, which is configured to acquire parameter information relating to a process parameter of an extrusion-based manufacturing process that can be carried out or is carried out by means of the apparatus 1 and/or to an object parameter of a three-dimensional object that is to be manufactured or is manufactured by means of the apparatus 1, and to generate position information and/or time information describing a detection position and/or a detection time of corresponding parameter information.

By means of the device 6, parameter information can thus be acquired which describes process parameters of an extrusion-based manufacturing process that can be carried out or is carried out by means of the apparatus 1, i.e. generally parameters which directly or indirectly describe an extrusion-based manufacturing process which can be carried out or is carried out by means of the apparatus 1, and/or which relate to object parameters of a three-dimensional object which is to be manufactured or is manufactured by means of the apparatus 1, i.e. generally parameters which directly or indirectly describe a three-dimensional object which is to be manufactured or is manufactured by means of the apparatus 1. By means of corresponding parameter information—which may, for example, be data that can be processed by means of data processing—both manufacturing processes that can be carried out or are carried out by means of the apparatus 1 and three-dimensional objects that can be manufactured or are manufactured by means of a manufacturing process that can be carried out or is carried out by means of the apparatus 1 can therefore be described at least partially, if necessary completely.

Corresponding process parameters that can be detected by means of the device 6 can, for example, concern the following process parameters:

A process parameter can describe at least one chemical and/or at least physical parameter of a process space in which an extrusion-based manufacturing process that can be performed or is performed by means of the apparatus 1 takes place. A corresponding chemical parameter of a process space may in particular be a chemical composition of an atmosphere prevailing within the process space, in particular a gas atmosphere. A corresponding chemical parameter may also be a gradient of an atmosphere prevailing within the process space, in particular a gas atmosphere. A corresponding physical parameter of a process space may in particular be a pressure prevailing within the process space or a temperature prevailing within the process space. A corresponding physical parameter can also be a gradient of a pressure prevailing within the process space or a temperature prevailing within the process space.

Alternatively or additionally, a corresponding process parameter may describe at least one chemical and/or geometric and/or physical parameter of at least one extrusion material that can be used or is used in the context of an extrusion-based manufacturing process that can be carried out or is carried out by means of the apparatus 1. A corresponding chemical parameter of an extrusion material can in particular be a chemical composition of an extrusion material. A corresponding chemical parameter may also be a gradient of a chemical composition of an extrusion material. A corresponding geometric parameter of an extrusion material, in particular of an extrusion material web applied to a substrate, can in particular be a dimension, in particular a height, length, width, and/or a shape, in particular a cross-sectional shape, of an extrusion material, in particular of a material or melt strand applied to a substrate or of a material or melt strand applied to a substrate. A corresponding geometric parameter can also be a gradient of a dimension, in particular a height, length, width, and/or a shape, in particular a cross-sectional shape, of an extrusion material, in particular of a material or melt strand applied to a substrate or of a material or melt strand applied to a substrate. A corresponding physical parameter of an extrusion material may be, in particular, a density, a strength, a temperature, a surface texture or a viscosity of an extrusion material. A corresponding physical parameter may also be a gradient of a density, a strength, a temperature, a surface condition, or a viscosity of an extrusion material.

Alternatively or additionally, a corresponding process parameter may describe a parameter, in particular a movement parameter, possibly local and/or temporal, of a movement path of the extrusion unit 2 and/or of a material or melt strand applied to a substrate via the extrusion unit 2 or of a material or melt strand applied to a substrate.

Alternatively or additionally, a corresponding process parameter may describe a parameter of a substrate, such as the building platform 3. A corresponding parameter of a subsurface can be in particular a temperature, a surface condition, of a subsurface. A corresponding parameter can also be a gradient of a temperature or a surface condition of a substrate.

Corresponding object parameters that can be detected by means of the device 6 can, for example, concern the following object parameters:

A corresponding object parameter may describe at least one chemical and/or geometric and/or at least physical parameter of a three-dimensional object or object section to be produced or produced by means of the apparatus 1. A corresponding chemical parameter may in particular be a chemical composition of a three-dimensional object or object section to be produced or produced by means of the apparatus 1. A corresponding chemical parameter may also be a gradient of a chemical composition of a three-dimensional object or object section to be produced or produced by means of the apparatus 1. A corresponding geometric parameter may in particular be a dimension, in particular a height, length, width, and/or shape, in particular a cross-sectional shape, of a three-dimensional object or object section to be produced or produced by means of the apparatus 1. A corresponding geometric parameter can also be a gradient of a dimension, in particular a height, length, width, and/or a shape, in particular a cross-sectional shape, of a three-dimensional object or object section to be produced or produced by means of the apparatus 1. A corresponding physical parameter can in particular be a density, a mass, a surface quality, a strength, of a three-dimensional object or object section to be produced or produced by means of the apparatus 1. A corresponding physical parameter may also be a gradient of a density, a mass, a surface quality, or a strength of a three-dimensional object or object section to be produced or produced by means of the apparatus 1.

The device 6 is, as mentioned, in addition to the detection of corresponding parameter information also configured for the generation of position information and/or time information, such as position coordinates and/or time coordinates, which describe a detection position and/or a detection time of a corresponding parameter information. In particular, the device 6 is also configured for assigning position information and/or time information describing a detection position and/or a detection time of a corresponding parameter information to respective parameter information. By means of the device 6, corresponding descriptive position information and/or time information can therefore be generated for the respective detected parameter information and assigned to it. Each piece of parameter information can therefore be provided with a “position and/or time stamp” by means of data processing, by means of which it can be identified at which position and/or at which time the respective piece of parameter information was detected. The position can be described by parameters, such as coordinates, which define a unique position of the position in a spatial volume, i.e. in particular in a construction volume of the apparatus 1.

The device 6 can therefore comprise, on the one hand, a hardware- and/or software-implemented detection device 7, which is configured to acquire parameter information, and, on the other hand, a hardware- and/or software-implemented assignment device 8, which is configured to assign to a corresponding parameter information position information and/or time information, which describes a respective detection position and/or a detection time of corresponding parameter information.

By means of the device 6, therefore, a meaningful process monitoring and evaluation can be realized, which can take into account both corresponding process parameters and corresponding object parameters, so that a spatially and/or temporally resolved data image of a manufacturing process that can be carried out or is carried out by means of the apparatus 1 can be obtained, as well as a spatially and/or temporally resolved data image of a three-dimensional object to be produced or produced by means of a manufacturing process that can be carried out or is carried out by means of the apparatus 1. In particular, the possibility of generating or assigning corresponding position information and/or time information to respective parameter information provides a meaningful image of a manufacturing process or the (successive) construction of a three-dimensional object, since the manufacturing process or the (successive) construction of a three-dimensional object can be reconstructed, if necessary, in real time, with spatial and/or temporal resolution.

The detection device 7 may comprise one or more detection elements 7.1 configured to detect parameter information. The detection device 7 can in particular be configured as a sensor device, so that the detection elements 7.1 can each be configured as sensor elements.

In particular, the detection device 7 may be configured, for example, as an acoustic and/or optical and/or thermal detection device, which comprises at least one detection or sensor element for acoustic and/or optical and/or thermal detection of parameter information. The detection device 7 may therefore be configured in particular as an acoustic and/or optical and/or thermal sensor device which comprises an acoustic and/or optical and/or thermal sensor element. An acoustic detection or sensor element can be, for example, a sound element, in particular an ultrasonic sensor element, an optical detection or sensor element can be, for example, an image detection element, such as a CCD sensor element, a pixel sensor element, etc., a thermal detection or sensor element can be, for example, a temperature detection element, such as an infrared sensor element. In principle, all detection or sensor elements can be used which enable the detection of corresponding parameter information.

Of course, the device 6 or the detection device 7 or an evaluation device 9 optionally assigned to the detection device 7 in terms of hardware and/or software can be configured to generate corresponding parameter information on the basis of the signals supplied by respective detection or sensor elements. A corresponding evaluation device 9 can, if present, form a hardware and/or software component of the device 6.

The device 6 or a hardware- and/or software-implemented plausibility apparatus 16 optionally assignable to or associated with the device 6 can further be configured to check, for example, parameter information supplied by different detection elements 7.1 of the detection device 7 with regard to at least one plausibility criterion. For example, parameter information, such as temperature information, supplied by a first detection element 7.1 can be compared with parameter information, such as temperature information, supplied by a further detection element 7.1, and the result of the comparison can be checked for plausibility with regard to at least one plausibility criterion, such as a specific absolute or relative deviation, a reference value, etc. A corresponding plausibility apparatus 16, if present, can form a hardware and/or software component of the device 6.

The device 6 can be configured to generate one or more image information items describing a one- or multi-dimensional image of corresponding parameter information. The device 6 can therefore be configured to process corresponding parameter information and/or corresponding position information and/or time information by means of data processing to form a one-dimensional or multi-dimensional image of a manufacturing process which can be carried out or is carried out by means of the apparatus 1 and/or of a three-dimensional object which can be manufactured or is manufactured by means of the apparatus. A corresponding image may include the aforementioned spatially and/or temporally resolved illustration of a manufacturing process or of the structure of a three-dimensional object, which can enable the likewise aforementioned spatially and/or temporally resolved reconstruction of the manufacturing process or of the structure of the three-dimensional object.

The apparatus 1 may further comprise at least one output device 10, which is configured to output corresponding image information at or via an output element. The term “output” in this context means both a display of corresponding image information on an output element comprising a display surface, such as a display, and the wired or wireless data transmission of corresponding image information via an output element comprising a data transmission interface. Corresponding image information—the same also applies to corresponding parameter information together with position information and/or time information assigned thereto—can be transmitted, as indicated by the arrow P1, for example for the purpose of further evaluation or processing or mere storage, for example in order to realize archiving or documentation of a manufacturing process carried out by means of the apparatus 1, by wire or wirelessly to an external communication partner 11, such as, for example, an external data processing device and/or an external data storage. For data transmission of corresponding information, the apparatus 1 may comprise a data transmission device not shown.

The device 6 or a hardware and/or software comparison apparatus 12 that can be assigned or is assigned to the device 6 can furthermore be configured to compare corresponding parameter information with at least one, in particular corresponding, reference parameter information and to generate comparison information describing a respective comparison result. By means of respective comparison information, in turn, meaningful statements can be made, in particular spatially and/or temporally resolved, about the quality of a manufacturing process which can be carried out or is carried out by means of the apparatus 1 and/or of a three-dimensional object which is to be manufactured or is manufactured by means of the apparatus 1, so that very relevant and meaningful information can be obtained with regard to the aforementioned process monitoring and evaluation.

The apparatus 1 may comprise a control apparatus 13 implemented in terms of hardware and/or software, which is configured for controlling the operation of the apparatus 1, in particular the operation of the extrusion unit 2 or of the support device 5 supporting the extrusion unit 2. In particular, the control apparatus 13 may be configured to control the operation of the apparatus 1, in particular the operation of the extrusion unit 2 or the support device 5 supporting the extrusion unit 2, on the basis of corresponding parameter information and/or on the basis of corresponding comparison information. Consequently, corresponding parameter information and/or comparison information may be used as a basis for controlling the operation of the apparatus 1, in particular the extrusion unit 2 or the support device supporting the extrusion unit 2. This can also include that on the basis of corresponding parameter information and/or comparison information, for example, certain operating parameters of the apparatus 1 can be adjusted, in particular in real time, at least temporarily, for example in order to compensate and/or offset detected deviations of a certain process parameter and/or object parameter. Similarly, process parameters and/or object parameters can be adapted or changed, for example in order to compensate and/or offset detected deviations of a particular process parameter and/or object parameter. Specifically, a corresponding adaptation may include, for example, an at least temporary adaptation or modification of a movement path of the extrusion unit 2 or of the support device 5 supporting the extrusion unit 2, or an at least temporary adaptation or modification of the application or discharge quantity of extrusion material onto a substrate, or an at least temporary adaptation or modification of a movement profile, in particular a movement path, a movement speed, etc., of the support device 5 supporting the extrusion unit 2.

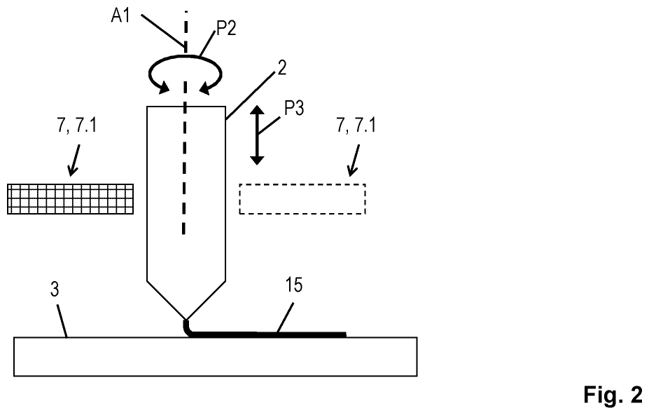

With regard to the arrangement of the device 6, i.e. in particular the detection device 7, there are basically two different possibilities, which are explained in more detail below also with reference to the exemplary embodiments shown in FIGS. 2-5. The device 6 or the detection device 7 can—as shown in the exemplary embodiment shown in FIG. 1—either be stationary and thus immovable or fixed in position or location, or—as shown in the exemplary embodiments shown in FIGS. 2-5—non-stationary and thus movable or not fixed in position or location.

In the stationary variant shown in FIG. 1, the device 6 or the detection device 7 may be arranged or formed directly or indirectly on a stationary component of the apparatus 1, such as a housing structure 14, the building platform 3, etc.

In the non-stationary variant shown in FIGS. 2-5, the device 6 or the detection device 7 can be arranged or formed directly or indirectly on a non-stationary and thus a movably mounted component of the device, such as, for example, on or in a movably mounted arm of the or a robot device or on or in the, as mentioned, movably mounted extrusion unit 2, whereby it is not itself (actively) movably mounted relative to the non-stationary component of the apparatus 1. Movements of the device 6 or of the detection device 7 typically result here from the movements of the movably mounted component of the apparatus 1.

Likewise, in the non-stationary variant, the device 6 or the detection device 7 may be arranged or formed directly or indirectly on or in a stationary component of the apparatus 1, such as the housing structure 14, the building platform 3, etc., wherein it is arranged or formed to be movable relative to the stationary component of the apparatus 1 in at least one degree of freedom of movement. Movements of the device 6 or the detection device 7 typically result here from the (active) movements of the device 6 or the detection device 7 relative to the stationary component of the apparatus

Likewise, as FIGS. 2-5 each show by way of example, the device 6 or the detection device 7 in the non-stationary variant can be arranged or formed on or in a non-stationary and thus movably mounted component of the apparatus 1, such as, for example, on or in a movably mounted arm of the or a robot device or—as FIGS. 2-5 each show by way of example—on or in the movably mounted extrusion unit 2, i.e., in particular in the region of the outlet region 2.3 of the extrusion unit 2.

Basically, for the non-stationary variant, movements of the detection device 7 can be performed on the basis of control data, i.e. in particular movement data, of the extrusion unit 2. Movements of the detection device 7 can thus directly or indirectly follow movements of the extrusion unit 2, which are described by corresponding control or movement data.

Alternatively or supplementarily, however, it is possible that movements of the detection device 6 are carried out on the basis of other data, i.e., for example, on the basis of detection data of certain chemical and/or physical parameters, such as, for example, a possibly varying temperature of, for example, a substrate, a chemical atmosphere varying, for example, due to an outgassing of an extrusion material, and so on. Accordingly, the detection device 7 can be moved, for example, following a certain sensed temperature profile. Corresponding detection data can be detected by the detection device 7 or its associated detection elements 7.1 or by a detection device (not shown) separate from the detection device 7.

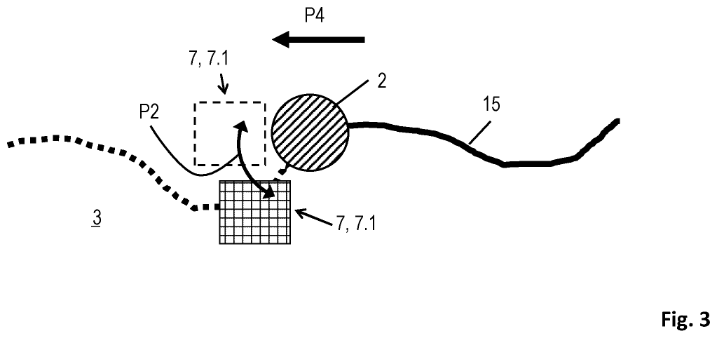

The exemplary embodiment shown in FIGS. 2, 3, where FIG. 2 shows a side view and FIG. 3 shows a top view, specifically shows that the detection device 7 or a detection element 7.1 can additionally be arranged or configured to be movable in at least one degree of freedom of movement relative to the extrusion unit 2, which is itself mounted movably. Movements of the detection device 7 or of the detection element 7.1 can result here from the (active) movements of the extrusion unit 2 and/or from the (active) movements of the detection device 7 or of the detection element 7.1 relative to the extrusion unit 2. The detection device 7 or the detection element 7.1 can here be movable relative to the extrusion unit 2 depending on or independently of movements of the extrusion unit 2. In this way, combined or superimposed movements of the detection device 7 or of the detection element 7 can be realized, which result from a combination of one or more movements of the extrusion unit 2, e.g. relative to a substrate, and on the other hand one or more movements of the detection device 7 or of the detection element 7.1, e.g. relative to the extrusion unit 2, which are movably mounted on or in the extrusion unit 2.

For all corresponding embodiments, corresponding degrees of freedom of movement of respective non-stationary components of the apparatus 1 and the detection device 7 or the detection element 7.1, as indicated in FIG. 2 by the double arrows P2 and P3, can be translational and/or rotational degrees of freedom of movement. Translational movements of the detection device 7 or of the detection element 7.1 can take place, as indicated by double arrow P3, in particular along a translation axis defined by the extruder axis A2 or along a translation axis oriented at an angle, i.e. in particular at right angles, to the extruder axis A1. Rotational movements of the detection device 7 or of the detection element 7.1 can be made, as indicated by the double arrow P2, in particular about an axis of rotation defined by the extruder axis A1 or an axis of rotation oriented at an angle, i.e. in particular at right angles, to the extruder axis A1. In principle, it is therefore possible to realize changes in the orientation, in particular with unchanged position, or changes in the position, in particular with unchanged orientation, of the detection device 7 or of the detection element 7.1 by means of corresponding movements of the detection device 7 or of the detection element 7.1.

For the sake of completeness, it should be noted that FIGS. 2-5 show a corresponding melt strand 15. In addition, in FIG. 3 an exemplary direction of movement of the extrusion unit 2 is shown by the arrow P4; the dashed section of the melt track or melt strand 15 thus represents a future application of extrusion material to a substrate, such as the building platform 3.

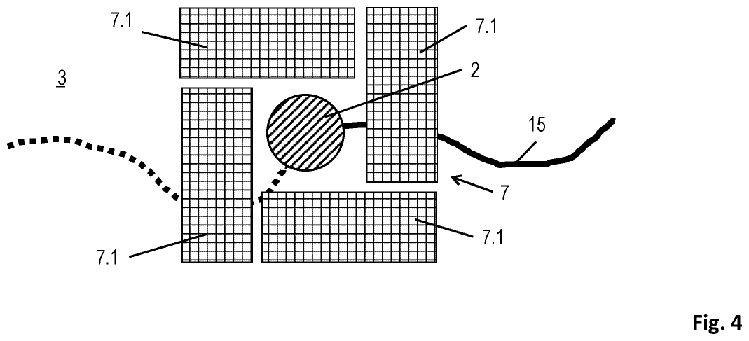

Based on the exemplary embodiment shown in FIG. 4, it can be seen that the detection device 7, as mentioned, may comprise several detection elements 7.1. In the exemplary embodiment shown in FIG. 4, the detection elements 7.1 can be arranged to form a detection element arrangement, in particular forming an array. In the exemplary embodiment shown in FIG. 4, the array is a planar structure which, by way of example, comprises four detection elements 7.1. The rectangular shape of the detection elements 7.1 is also to be understood as exemplary. By means of a corresponding detection element arrangement, a particularly ring-like detection region can be defined. In this case, respective detection elements 7.1 can each be assigned to at least one partial region in order to detect corresponding parameter information in the respective partial region.

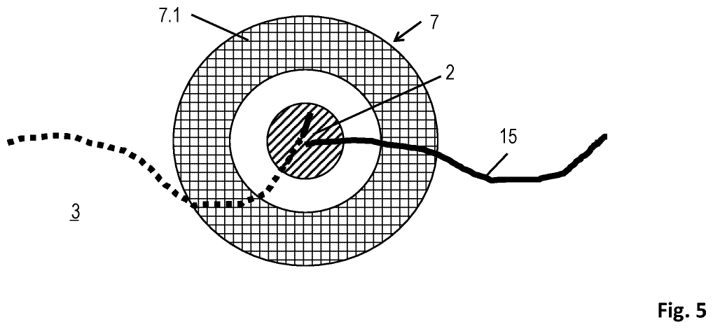

Based on the exemplary embodiment shown in FIG. 5, it can be seen that one or more detection elements 7.1 can also form an array in the form of an annular structure. An annular detection region in particular can be defined by a corresponding detection element array. In this case, respective detection elements 7.1 can in turn each be assigned to at least one subregion in order to detect corresponding parameter information in the respective subregion.

On the basis of the embodiments shown in FIGS. 2-5, it is therefore evident that, depending on the specific arrangement or orientation of the detection device 7 or of the respective detection elements 7.1 and depending on the specific path of movement of the extrusion unit 2, parameter information can be detected, for example, in advance of and/or in retrospect to a material or melt strand to be applied or applied to a substrate by means of the extrusion unit 2 or to a material or melt strand 15 to be applied to a substrate. This can provide very relevant and meaningful information with regard to the aforementioned process monitoring and evaluation.

Via a correspondingly configured detection device 7, parameter information can thus be detected, e.g., in advance and/or in retrospect of a material or melt strand to be applied to a substrate by means of the extrusion unit 2 or of a material or melt strand 15 to be applied to a substrate. A lateral detection of parameter information with respect to a longitudinal extension of a corresponding material or melt strand or a corresponding material or melt strand 15 is also conceivable.

Parameter information can thereby be detected, in particular also simultaneously with a movement of the extrusion unit 2 along a movement path of the extrusion unit 2 following a cross-section of a three-dimensional object to be produced, in which a material or melt strand or a material or melt strand 15 is applied to a substrate, in one or more alignments and/or positions around the extrusion unit 2 or the outlet region 2.3 of the extrusion unit 2, so that very relevant and meaningful information can be obtained with regard to the aforementioned process monitoring and evaluation.

In all exemplary embodiments, the movable mounting of the detection device 7 can be implemented via at least one drive device (not shown) which can be directly or indirectly assigned or associated with the detection device 7, in particular a motor drive device (not shown), which is configured to generate a drive force or a corresponding drive torque which sets the detection device 7 in motion in at least one degree of freedom of movement. In addition, the detection device 7 can be assigned or associated with a guide device (not shown), which comprises one or more guide elements, which in each case define at least one movement path or at least one degree of freedom of movement, along which or in which the detection device 7 can be moved.

In general, it should be noted for exemplary embodiments of the detection device 7 with several detection elements 7.1 that the detection regions of the respective detection elements 7.1 can overlap at least in sections, if necessary, completely. Consequently, in a corresponding overlapping region, several parameter information items of the same, similar or different information content can be acquired via several, possibly different, detection elements 7.1, so that very relevant and meaningful information can be obtained with regard to the aforementioned process monitoring and evaluation.

Furthermore, for embodiments of the detection device 7 with multiple detection elements 7.1, it is generally to be noted that the detection elements 7.1 are either permanently operated or, for example to ensure that only relevant parameter information is detected, based on at least one, e.g. static or dynamic, location criterion, i.e. e.g. only when one or more detection elements 7.1 are in a certain orientation and/or position, and/or on the basis of at least one, e.g. static or dynamic, time criterion, i.e. e.g. only at certain points in time, and/or on the basis of a static or dynamic movement criterion of the extrusion unit 2, i.e. e.g. only when the extrusion unit 2 is moving along an extrusion material web. Respective location and/or time criteria can be determined, for example, on the basis of construction data of a respective three-dimensional object to be produced.

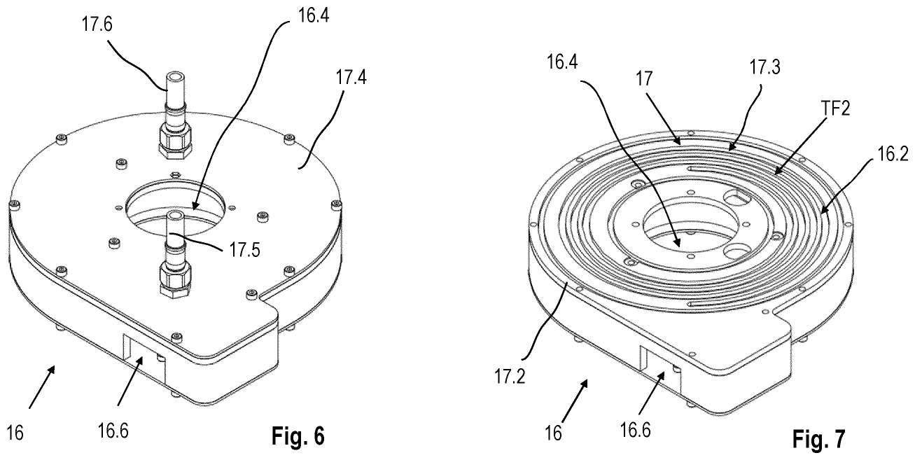

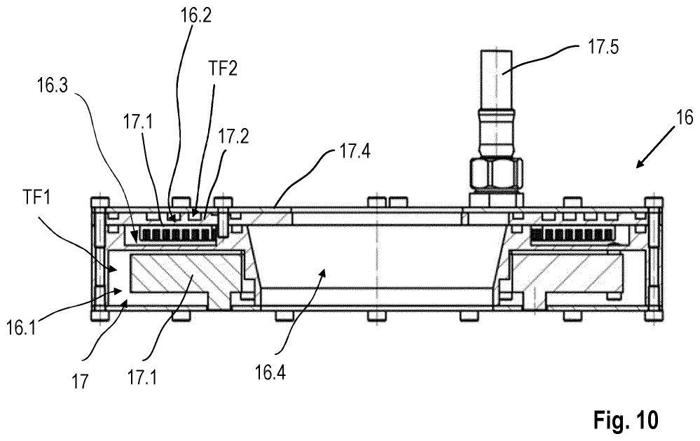

FIGS. 6 to 10 each show a principle illustration of a housing assembly 16 of an apparatus 1 according to an exemplary embodiment. Here, FIGS. 6-9 each show various horizontally cut views and FIG. 10 a transverse cut view of the housing assembly 16, which provide a view of the interior of the housing assembly 16.

Accordingly, on the basis of FIGS. 6-0, it is apparent that the apparatus 1 can comprise a housing assembly 16 on or in which functional components of the or a detection device 7 can be arranged or formed. For this purpose, the housing assembly 16 delimits one or more chamber-like spatial volumes 16.1-16.3. The housing assembly 16 can be arranged or formed on a movably mounted component of the apparatus 1, such as, for example, on or in a movably mounted arm of the or a robot device or on or in the movably mounted extrusion unit 2, i.e., in particular in the region of the outlet region of the extrusion unit 2.

On the basis of FIGS. 6-10, it can be seen that the housing assembly 16 can have an opening 16.4 through which the extrusion unit 2 can pass or through which, for example if the extrusion unit 2 is arranged above the housing assembly 16, a building material to be applied to a substrate can pass.

It is further apparent from FIGS. 6-10 that the apparatus 1 can comprise a temperature control device 17 which is assigned to the detection device 7, i.e. in particular to the detection elements 7.1 associated with the detection device 7, and which is configured for temperature control, i.e. in particular for cooling, of the detection device 7 or the detection elements 7.1. The possibility of temperature control of the detection elements 7.1 can ensure the intended operation of the detection device 7, i.e. in particular the intended detection of corresponding parameter information, even under adverse thermal conditions, i.e. in particular at high temperatures. In addition, thermally induced failures or damage to the detection elements 7.1 can be avoided.

In the exemplary embodiment shown in FIGS. 6-10, the temperature control devicel7 is configured as a heat exchanger device that can also be referred to as a heat transfer device. The temperature control devicel7 is thus configured to receive thermal energy of a first energy level from the detection elements 7.1, e.g. via a first temperature control fluid TF1 flowing along the detection elements 7.1—this can be a gas, such as air, for example—and to transfer this energy to the detection elements 7.1 and to transfer this energy to temperature control structures 17.1, for example in the form of cooling fin structures, and also to a second temperature control fluid TF2, for example a liquid such as oil, water, etc., with the interposition of a heat transfer structure 17.2 in the form of an intermediate wall, to be transferred.

In the exemplary embodiment, the heat exchanger apparatus 17 comprises two flow channel structures. A first flow channel structure, which can be flowed through or through by the first temperature control fluid TF1 and can be seen in FIG. 9, extends through a first spatial volume 16.1, in which the detection elements 7.1 are arranged or formed. A second flow channel structure through which the second temperature control fluid TF2 can flow extends through a second spatial volume 16.2 separated from the first spatial volume 16.1 by the heat transfer structure 17.2. On the basis of FIGS. 6, 7, it can be seen that the second spatial volume 16.2 is formed, for example, by groove-like recesses 17.2. by groove-like recesses 17.3, which are covered on the upper side by a plate-like or plate-shaped end or cover element 17.4, on which one or more discharge elements 17.5 and/or supply elements 17.6 for discharging and/or supplying the second temperature control fluid TF2 can be arranged or formed. This configuration of the heat exchanger apparatus 17 with two separate but thermally couplable or coupled flow channel structures enables efficient dissipation of thermal energy and thus efficient cooling of the detection elements 7.1.

One or more flow generation apparatuses 17.7, i.e., e.g., blower and/or pump devices, can be assigned to respective flow channel structures, which enable the respective temperature control fluid TF1, TF2 to be conveyed through the spatial volumes 16.1-16.3 associated with the respective flow channel structures. A corresponding flow generation apparatus 17.7—configured as a blower device as an example—is shown in FIG. 9 as an example for the flow channel structure through which the first temperature control fluid TF1 can flow.

On the basis of FIGS. 9, 10, it is again apparent that the first spatial volume 16.1 can be a chamber-like or -shaped spatial volume of the housing assembly 16, on or in which the detection elements 7.1 can be arranged or formed. The second spatial volume 16.2, as shown in FIG. 10, which is also chamber-like or -shaped, can be a spatial volume of the housing assembly 16 which, as mentioned, is separated from the first spatial volume 16.1 by the wall structure serving as a heat transfer structure 17.2, so that there is a transfer of thermal energy but no possibility of mixing of the temperature control fluids TF1, TF2 flowing through the respective spatial volumes 16.1, 16.2.

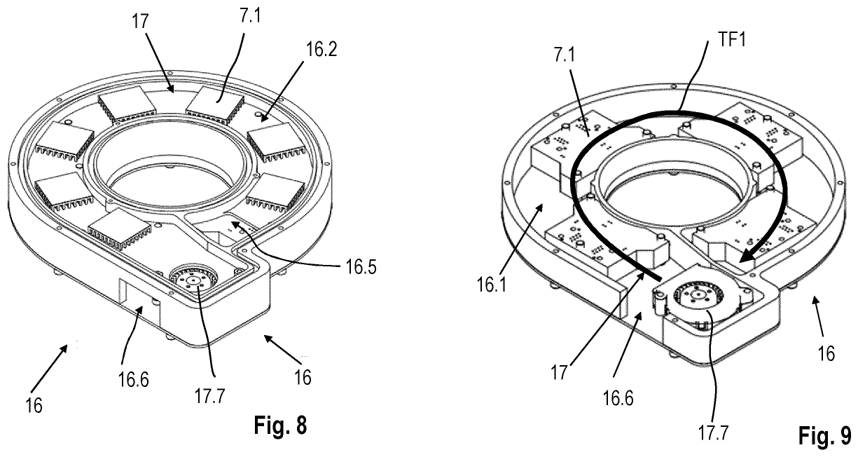

In the exemplary embodiment, the housing assembly 16 also comprises a chamber-like or chamber-shaped third spatial volume 16.1 communicating with the first spatial volume through which the first temperature control fluid TF1 can flow or is flowing through an opening 16.5 visible in FIG. 8. 3.The aforementioned temperature control structures 17.1 are arranged in the third volume 16.3 and are thermally coupled via the heat transfer structure 17.2 to the second volume 16.2 through which the second temperature control fluid TF2 flows.

In connection with FIGS. 6-9, it should further be noted that the housing assembly 16 can optionally have a connection opening 16.6 via which, for example, a data and/or supply cable (not shown) associated with the detection elements 7.1 can be connected.

In connection with all exemplary embodiments, it should be mentioned once again that one or more detection elements 7.1 can be arranged or formed so as to be movable in at least one translatory and/or rotatory degree of freedom of movement relative to the outlet region of the extrusion unit 2 in the region of the outlet region. Corresponding rotational movements can, as likewise mentioned, also take place about an axis of rotation oriented at right angles and thus transversely to the extruder axis, so that one or more detection elements 7.1 can be pivotably mounted, which makes it possible to align the detection range of the respective detection elements 7.1 directly with the or an region below the outlet region of the extrusion unit 2 in order to detect parameter information in this region.

Equally, however, it is conceivable that the detection elements 7.1 are arranged or aligned with a respective detection region which is aligned with the or a region below the outlet region of the extrusion unit 2.

With the embodiments shown in the Figures, a method for extrusion-based manufacturing of at least one three-dimensional object can be implemented. The method comprises the following steps: detection of at least one parameter information relating to a process parameter of an extrusion-based manufacturing process which can be carried out or is carried out by means of the apparatus 1 and/or an object parameter of a three-dimensional object which is to be manufactured or is manufactured by means of the apparatus 1, and generation of a position information and/or time information describing a detection position and/or a detection time of a corresponding parameter information object information.

Individual, multiple, or all of the features described in connection with a particular embodiment can be combined with individual, multiple, or all of the features described in connection with at least one other embodiment.

1. Apparatus for the extrusion-based manufacture of at least one three-dimensional object, comprising at least one extrusion unit which is configured for melting an extrusion material and/or for applying a molten extrusion material to a substrate, characterized by
a device which is configured to acquire parameter information relating to a process parameter of an extrusion-based manufacturing process which can be carried out or is carried out by means of the apparatus and/or an object parameter of a three-dimensional object which is to be manufactured or is manufactured by means of the apparatus, and to generate position information and/or time information describing a detection position and/or a detection time of corresponding parameter information.

2. Apparatus according to claim 1, characterized in that the device comprises a detection device which comprises at least one detection element which is configured to detect parameter information.

3. Apparatus according to claim 2, characterized in that the detection device is an acoustic or optical or thermal detection device which comprises at least one detection element for acoustic or optical or thermal detection of parameter information.

4. Apparatus according to claim 1, characterized in that the device, in particular the detection device, is mounted movably in at least one degree of freedom of movement, in particular relative to the or a substrate.

5. Apparatus according to claim 1, characterized in that the device is arranged or formed on or in the extrusion unit.

6. Apparatus according to claim 5, characterized in that the device, in particular at least one detection element, is arranged or formed a region of an outlet region of the extrusion unit.

7. Apparatus according to claim 6, characterized in that the device, in particular the detection element, is arranged or configured to be movable in at least one degree of freedom of movement relative to the outlet region in the region of the outlet region.

8. Apparatus according to claim 1, characterized in that the device comprises a plurality of detection elements which are arranged to form a detection element array, in particular forming a planar array.

9. Apparatus according to claim 1, characterized in that the process parameter at least describes a chemical and/or at least physical parameter of a process space in which
the extrusion-based manufacturing process that can be carried out or is carried out by means of the apparatus takes place, and/or
describes at least one chemical and/or geometric and/or physical parameter of at least one extrusion material that can be used or is used in the context of an extrusion-based manufacturing process that can be carried out or is carried out by means of the apparatus, and/or
describes the parameter, in particular a movement parameter, possibly local and/or temporal, of a movement path of the extrusion unit and/or of an extrusion material web applied to a substrate via the extrusion unit, and/or
describes the parameter, in particular a surface condition parameter, of substrate, such as a construction platform.

10. Apparatus according to claim 1, characterized in that the object parameter describes at least one chemical and/or geometric and/or at least physical parameter of the three-dimensional object or object section to be produced or produced within the scope of anth extrusion-based manufacture process which can be carried out or is carried out by means of the apparatus.

11. Apparatus according to claim 1, characterized in that the device is configured to generate image information describing a one- or multi-dimensional image of corresponding parameter information.

12. Apparatus according to claim 11, characterized by an output device which is configured to output corresponding image information to or via an output element.

13. Apparatus according to claim 1, characterized in that the device is configured to compare corresponding parameter information with at least one, in particular corresponding, reference parameter information and to generate comparison information describing a respective comparison result.

14. Apparatus according to claim 1, characterized by a control device which is configured to control the operation of the apparatus, in particular the operation of the extrusion unit of the apparatus, wherein the control device is configured to control the operation of the apparatus, in particular the operation of the extrusion unit of the apparatus, on the basis of corresponding parameter information and/or on the basis of corresponding comparison information.

15. Apparatus according to claim 1, characterized by a temperature control device which is assigned to the device and is configured for temperature control, in particular for cooling of the device.

16. Apparatus according to claim 15, characterized in that the temperature control device is configured as or comprises a heat exchanger device.

17. Apparatus according to claim 16, characterized in that the heat exchanger device comprises at least two flow channel structures, wherein a first flow channel structure through which a first temperature control fluid can flow extends through a first spatial volume in which the device, in particular at least one detection element of the detection device of the device, is arranged or formed, and a second flow channel structure through which a second temperature control fluid can flow extends through a second spatial volume separated from the first spatial volume by a heat transfer structure, in particular a wall structure.

18. Apparatus according to claim 1, characterized in that the detection region of one or more detection elements of the detection device of the device is alignable or aligned with a region below the outlet region of the extrusion unit.

19. Method for the extrusion-based manufacture of at least one three-dimensional object, in particular by means of an comprising the steps:
detection of parameter information relating to a process parameter of an extrusion-based manufacturing process which can be carried out or is carried out by means of the apparatus and/or relating to an object parameter of a three-dimensional object which is to be manufactured or is manufactured by means of the apparatus, as well as generation of position information and/or time information describing a detection position and/or a detection time of corresponding parameter information object information.
